(19) United States
(12) Patent Application Publication
(10) Pub. No.: US 2026/0332525 A1
(43) Pub. Date: Oct. 22, 2026

(54) COMMUNICATION CONTROL DEVICE, COMMUNICATION CONTROL SYSTEM, AND COMMUNICATION CONTROL METHOD

(71) Applicant: NEC Corporation, Tokyo (JP)

(72) Inventors: Atsushi NAGATA, Tokyo (JP); Toru Tomita, Tokyo (JP)

(73) Assignee: NEC Corporation, Tokyo (JP)

(21) Appl. No.: 19/642,853

(22) Filed: Apr. 9, 2026

(30) Foreign Application Priority Data
Apr. 21, 2025 (JP) 2025-069775

(51) Int. Cl. H04L 45/76; H04L 9/40; H04L 45/586

(52) U.S. Cl. CPC H04L 45/76; H04L 45/586; H04L 63/08

(57) ABSTRACT

A communication control device according to an aspect of the present disclosure includes a hypervisor implemented in hardware without intervention of a host OS, in which the hypervisor includes a virtual switch that controls communication with a connection destination, and the hypervisor routes the communication originating from the communication control device to the connection destination and the communication originating from the connection destination to the communication control device through the virtual switch.

### RELATED APPLCATION

This application is based upon and claims the benefit of priority from Japanese Patent Application No. 2025-069775, filed on Apr. 21, 2025, the disclosure of which is incorporated herein in its entirety by reference.

### TECHNICAL FIELD

The present disclosure relates to a communication control device, a communication control system, and a communication control method.

### BACKGROUND ART

There are techniques related to network communication control using virtualization technology.

JP 2015-39166 A discloses a technique in which a network interface card includes a virtual switch and applies a traffic flow policy for each virtual machine.

### SUMMARY

An object of the present disclosure is to provide a communication control device and the like capable of suppressing occurrence of a problem caused by an operating system (OS).

A communication control device according to an aspect of the present disclosure includes a hypervisor implemented in hardware without intervention of a host OS, in which the hypervisor includes a virtual switch that controls communication with a connection destination, and the hypervisor routes the communication originating from the communication control device to the connection destination and the communication originating from the connection destination to the communication control device through the virtual switch.

A communication control method according to an aspect of the present disclosure causes a hypervisor implemented in hardware without intervention of a host OS to route communication originating from an OS to a connection destination and communication originating from the connection destination to a communication control device through a virtual switch that controls the communication with the connection destination, the virtual switch being included in the hypervisor.

A communication control system according to an aspect of the present disclosure includes a communication control device and a VPN server, in which the communication control device includes a hypervisor implemented in hardware without intervention of a host OS, the hypervisor includes a virtual switch that controls communication with a connection destination, the hypervisor routes the communication originating from the communication control device to the connection destination and the communication originating from the connection destination to the communication control device through the virtual switch, the virtual switch includes a VPN client means for establishing communication with the VPN server, and a routing means for performing routing control based on a destination for the communication originating from the communication control device and the communication originating from the connection destination, and the VPN server includes an authentication means for executing authentication processing in response to a request from the communication control device, an access control means for controlling a range accessible from the communication control device depending on a result of the authentication, and a session management means for establishing the communication with the communication control device in response to successful authentication.

### BRIEF DESCRIPTION OF THE DRAWINGS

Exemplary features and advantages of the present disclosure will become apparent from the following detailed description in conjunction with the accompanying drawings in which:

FIG. 1 is a block diagram illustrating an exemplary functional configuration of a communication control device according to the present disclosure;

FIG. 2 is a conceptual diagram illustrating an exemplary structure of a virtual environment achieved in the communication control device according to the present disclosure;

FIG. 3 is a diagram schematically illustrating an exemplary configuration including the communication control device according to the present disclosure;

FIG. 4 is a first block diagram illustrating an exemplary functional configuration of a communication control system according to the present disclosure;

FIG. 5 is a first sequence diagram for explaining an exemplary operation of the communication control system according to the present disclosure;

FIG. 6 is a second sequence diagram for explaining an exemplary operation of the communication control system according to the present disclosure;

FIG. 7 is a second block diagram illustrating an exemplary functional configuration of the communication control system according to the present disclosure; and

FIG. 8 is a block diagram illustrating an exemplary hardware configuration of a computer device that implements the communication control device according to the present disclosure.

### EXAMPLE EMBODIMENT

Hereinafter, example embodiments of the present disclosure will be described with reference to the drawings.

### First Example Embodiment

An outline of a communication control device according to a first example embodiment will be described.

In a case of performing communication using a virtual private network (VPN) or the like between a terminal device and an access destination device, software for performing communication control related to the communication may be installed in the terminal device. Examples of the software for performing the communication control include a hypervisor. Examples of the communication control device according to the present disclosure include a device that performs communication control using a hypervisor implemented in hardware in a case of performing such communication.

The communication control device may be a terminal device. For example, the communication control device is a personal computer, but is not limited to this example. The communication control device may be a portable terminal such as a smartphone.

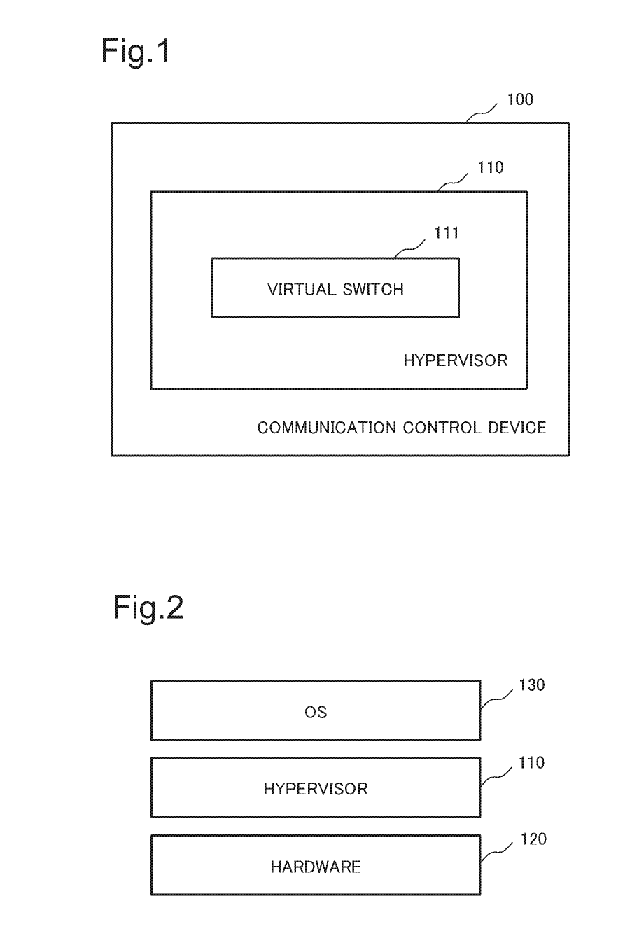

FIG. 1 is a block diagram illustrating an exemplary functional configuration of a communication control device 100. As illustrated in FIG. 1, the communication control device 100 includes a hypervisor 110.

The hypervisor 110 is installed in hardware. That is, the hypervisor 110 directly operates in the hardware.

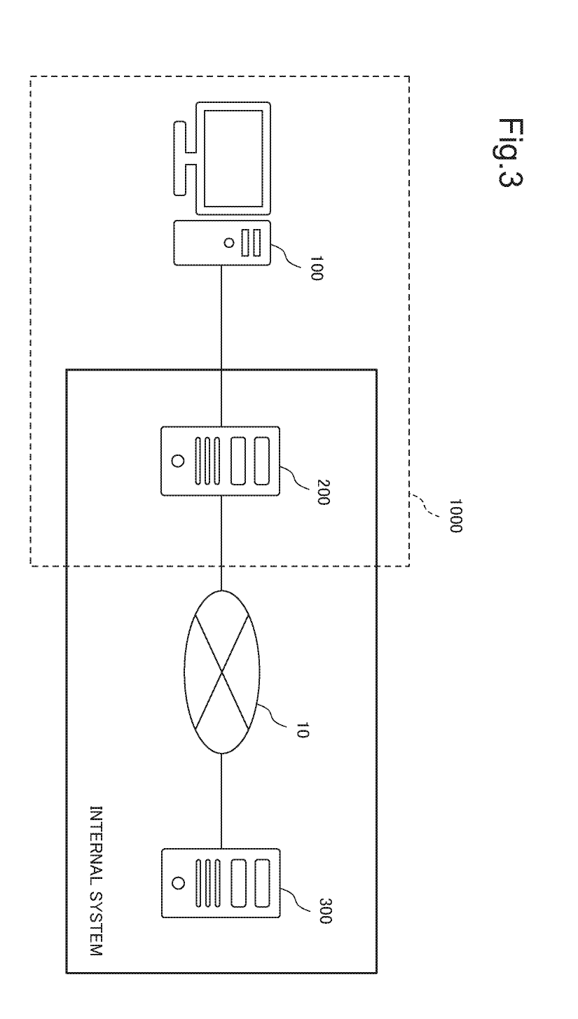

FIG. 2 is a conceptual diagram illustrating an exemplary structure of a virtual environment achieved in the communication control device 100. As illustrated in FIG. 2, the hypervisor 110 directly operates in the hardware. For example, the hypervisor 110 is implemented in a basic input/output system (BIOS) layer or a unified extensible firmware interface (UEFI) layer. In other words, a function of the hypervisor 110 is implemented as a function added to the BIOS layer or the UEFI layer. Then, an OS 130 is implemented on the hypervisor 110, and a virtual machine is implemented in the OS 130. As described above, the hypervisor 110 is implemented in the hardware without intervention of an OS such as a host OS. The hypervisor 110 may directly control the hardware.

In the example of FIG. 2, there may be a plurality of types of the OSes 130. For example, a plurality of virtual machines associated with a plurality of guest OSes may be implemented on the hypervisor 110.

The hypervisor 110 includes a virtual switch 111. The virtual switch 111 refers to a network switch. More particularly, the virtual switch 111 is a software-based network switch implemented on the hypervisor 110.

The virtual switch 111 is located between the OS 130 and hardware 120. The virtual switch 111 controls network traffic between the OS 130 and a connection destination (e.g., a server). In other words, the hypervisor 110 causes the virtual switch 111 to control the network traffic between the OS 130 and the connection destination.

For example, the virtual switch 111 establishes secure communication between the OS 130 and a VPN server. After the communication with the VPN server is established, the virtual switch 111 may transmit traffic generated from the OS 130 or may transfer traffic received from the VPN server to the OS 130. The virtual switch 111 has a function of managing routing to a communication destination. At this time, a routing table is set in the virtual switch 111. An access control list (ACL) may be set in the virtual switch 111. In that case, the virtual switch 111 determines a packet transfer destination and the like based on the ACL. For example, it is assumed that the ACL is managed in the VPN server. In that case, the ACL may be set in the virtual switch 111 under control of the VPN server. As described above, communication between the OS 130 and the connection destination is performed via the virtual switch 111. In other words, the hypervisor 110 routes communication originating from the OS 130 to the connection destination and communication originating from the connection destination to the device through the virtual switch 111.

As described above, the communication control device 100 according to the first example embodiment includes the hypervisor 110 implemented in the hardware 120 without intervention of the host OS. At this time, the hypervisor 110 includes the virtual switch 111 that controls communication with the connection destination. The hypervisor 110 routes communication originating from the OS to the connection destination and communication originating from the connection destination to the device through the virtual switch 111.

As a result, communication control in a layer below the OS 130 is achieved, whereby the communication control device 100 is enabled to perform communication control regardless of a type of the OS 130. Routing the communication through the virtual switch included in the hypervisor 110 is equivalent to communication being performed under the management of the hypervisor 110. That is, OS-independent communication control is performed. Thus, for example, it becomes difficult for an attacker to exploit vulnerability of the OS or vulnerability of an application on the OS to bypass the OS to access the network. That is, the communication control device 100 may suppress occurrence of a problem caused by the OS.

In virtualization technology, there is a hypervisor that manages a virtual machine and the like. For example, the hypervisor may control communication originating from the virtual machine to a connection destination.

JP 2015-39166 A discloses that a network interface card including a virtual switch operates as a virtual processor. That is, JP 2015-39166 A assumes that a host operating system (OS) is constructed in hardware, virtual hardware is constructed in the host OS, and then a hypervisor is constructed. In other words, the hypervisor in JP 2015-39166 A can be regarded as OS-dependent software.

In a case of using OS-dependent software, a problem caused by the OS may occur. For example, if vulnerability exists in the OS, the software may be affected by the vulnerability of the OS. For example, OS-dependent software may require different handling for each type and version of the OS.

According to the present disclosure, the occurrence of the problem caused by the OS may be suppressed.

### Second Example Embodiment

Next, a communication control device according to a second example embodiment will be described. In the second example embodiment, another example related to the communication control device described in the first example embodiment will be further described. A part of the description of content overlapping with that of the first example embodiment will be omitted.

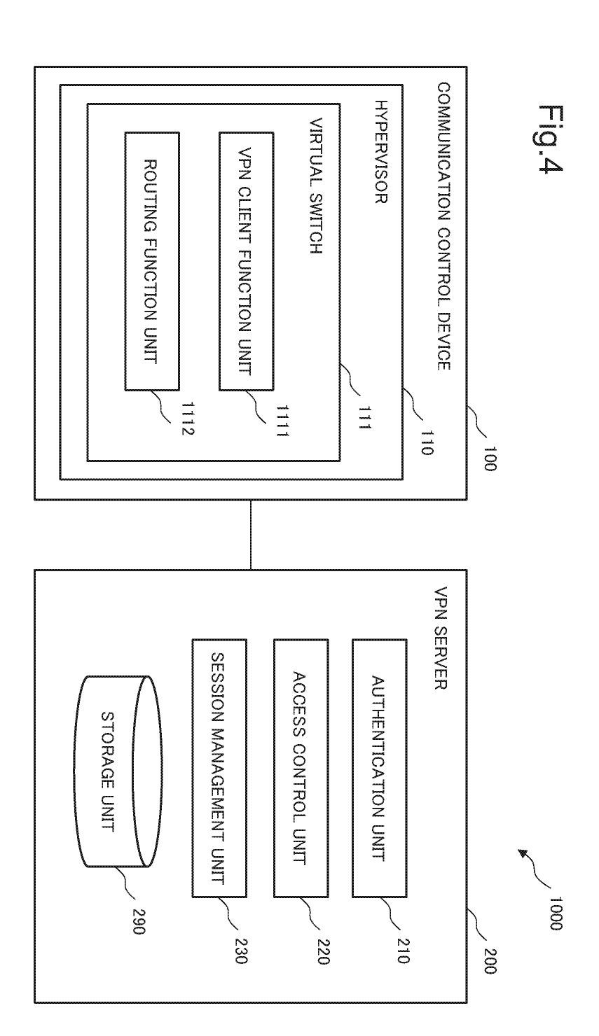

In the present example embodiment, an exemplary case where a communication control device 100 accesses a system of a specific organization will be described. FIG. 3 is a diagram schematically illustrating an exemplary configuration including the communication control device 100. More specifically, FIG. 3 illustrates an example of accessing an internal system from outside as an application example of the communication control device 100. In FIG. 3, the internal system includes a VPN server 200 and a server device 300. There may be a plurality of the VPN servers 200 and server devices 300. The VPN server 200 and the server device 300 are communicably connected to each other via a wired or wireless internal network 10. The server device 300 constructs, for example, various systems to be used in a company, such as a core system of the company.

For example, the communication control device 100 attempts to access the server device 300 from outside. At this time, the communication control device 100 first connects to the VPN server 200. That is, the communication control device 100 requests VPN connection. The VPN server 200 establishes secure communication with a client to be connected to the internal system. At this time, the VPN server 200 executes, for the client to be connected to the core system, authentication processing for determining access authority, approval processing for determining an accessible range, and the like. According to such processing, a communication control system 1000 is enabled to achieve, for example, a zero trust network related to the internal system.

The communication control device 100 and the communication control system 1000 including the communication control device 100 are applied in such a situation, for example. While an exemplary case where the communication control device 100 and the communication control system 1000 are applied to the situation of FIG. 3 is described in the present example embodiment, the application example of the communication control device 100 and the communication control system 1000 is not limited to this example. The configuration of the communication control system 1000 and internal system illustrated in FIG. 3 is not limited to this example.

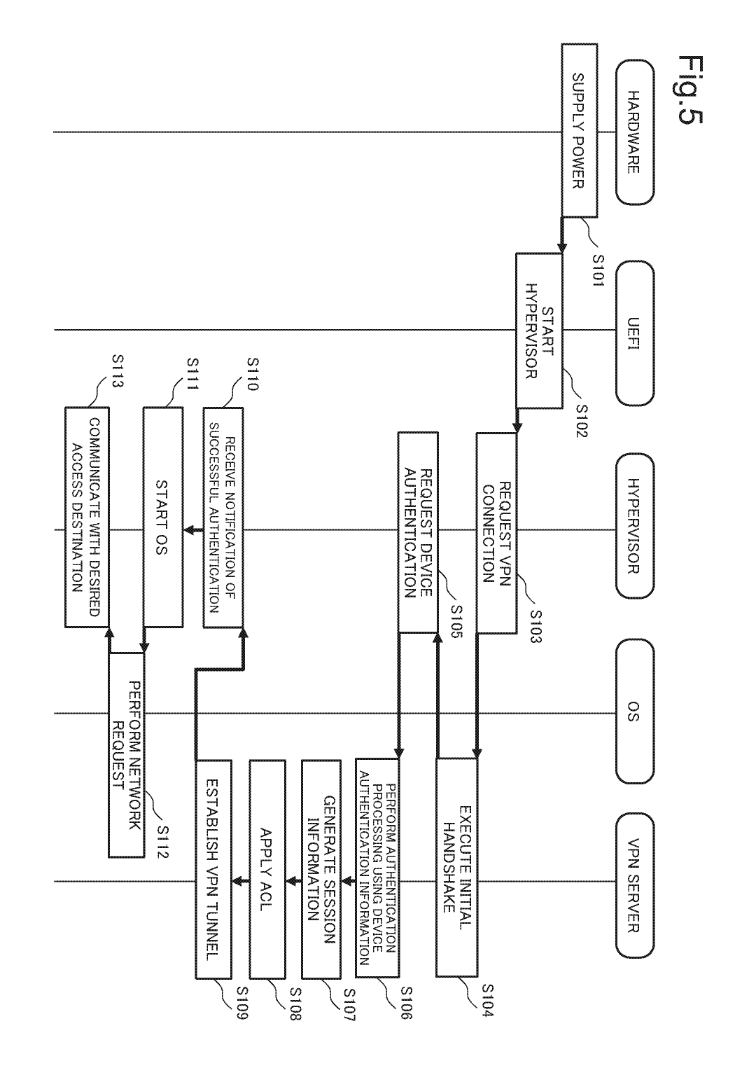

FIG. 4 is a first block diagram illustrating an exemplary functional configuration of the communication control system 1000. As illustrated in FIG. 4, the communication control system 1000 includes the communication control device 100 and the VPN server 200.

The communication control device 100 includes a hypervisor 110. Here, as illustrated in FIG. 2, the hypervisor 110 is implemented in hardware 120 without intervention of a host OS. In the present example embodiment, the hypervisor 110 is assumed to be implemented in a UEFI. Then, an OS 130 is implemented on the hypervisor 110. In this configuration, for example, if power is supplied to the UEFI from the hardware 120, the UEFI boots the hypervisor 110. Upon the boot of the hypervisor 110, the hypervisor 110 requests the VPN server 200 to establish VPN connection to be described later.

The hypervisor 110 includes a virtual switch 111. The virtual switch 111 includes a VPN client function unit 1111 and a routing function unit 1112. The VPN client function unit 1111 establishes communication with the VPN server. Examples of the communication include encrypted communication. The VPN client function unit 1111 is an example of a VPN client means. The routing function unit 1112 performs routing control based on a destination for communication originating from its own device and communication originating from a connection destination. The routing function unit 1112 is an example of a routing means.

Specifically, the VPN client function unit 1111 requests the VPN server 200 for the VPN connection. At this time, for example, the VPN client function unit 1111 reads connection information of the VPN server 200 set in advance. The connection information is stored in advance in, for example, a storage device (not illustrated) of the communication control device 100. The connection information is information required for connection to the VPN server 200. The connection information may be an address, a port number, and the like of the VPN server 200. Then, the VPN client function unit 1111 transmits a connection request packet to the VPN server 200 based on the connection information, thereby requesting VPN connection. At this time, the routing function unit 1112 determines a transmission path of the connection request packet. Then, the routing function unit 1112 transfers the connection request packet to a physical network interface.

The VPN client function unit 1111 requests the VPN server 200 to authenticate the device. At this time, the VPN client function unit 1111 transmits device authentication information after the startup of the hypervisor 110 and before the startup of the OS 130. For example, the VPN server 200 receives and verifies the device authentication information from the VPN client function unit 1111. The device authentication information may be stored in advance in a storage device (not illustrated) of the communication control device 100. The device authentication information is information capable of confirming identity of the client device. The device authentication information may be a unique identifier, an authentication element, or the like to be used to verify authority to access the system, resources, and the like in the VPN server 200. For example, the device authentication information is a certificate, a token, and a device identifier (ID) of the communication control device 100. Then, the VPN client function unit 1111 transmits an authentication response packet including the device authentication information to the VPN server 200, thereby requesting authentication. At this time, the routing function unit 1112 determines a transmission path of the authentication response packet. Then, the routing function unit 1112 transfers the authentication response packet to the physical network interface.

The VPN client function unit 1111 may simultaneously perform the VPN connection request and the device authentication request. The VPN client function unit 1111 may transmit profile information of the communication control device 100 at the time of the VPN connection request and the device authentication request. Examples of the profile information include a device ID, a MAC address, an OS type, hardware specifications, an implementation status of security software, and the like of the communication control device 100.

If the device authentication is requested and the authentication is made, an ACL based on the device authentication is applied by the VPN server 200. At this time, the VPN client function unit 1111 receives notification indicating that the authentication processing has succeeded from the VPN server 200. The notification corresponds to notification indicating establishment of the VPN connection. At this time, a VPN tunnel is established between the communication control device 100 and the VPN server 200. The routing function unit 1112 sets the VPN tunnel as a default gateway. That is, generated traffic is transmitted to the VPN server 200 through the VPN tunnel.

According to the processing as described above, the VPN client function unit 1111 establishes the encrypted communication with the VPN server 200. That is, the VPN client function unit 1111 transmits the authentication information regarding its own device to the VPN server 200 to establish the communication with the VPN server 200 after the startup of the hypervisor and before the startup of the OS 130.

The VPN client function unit 1111 requests the VPN server 200 to authenticate a user. For example, it is assumed that the user logs on an application implemented on the OS after the startup of the OS. At this time, the VPN client function unit 1111 obtains user authentication information. The user authentication information is information capable of confirming identity of the client user. The user authentication information may be a unique identifier, an authentication element, or the like to be used to verify authority to access the system, resources, and the like in the VPN server 200. For example, the user authentication information is information used for the logon. The user authentication information may be a user ID, a password, an authentication code, biometric information, or the like. Then, the VPN client function unit 1111 transmits an authentication response packet including the user authentication information to the VPN server 200, thereby requesting user authentication. At this time, the routing function unit 1112 transmits the authentication response packet through the VPN tunnel.

If the user authentication is requested and the authentication is made, an ACL based on the user authentication is applied by the VPN server 200. At this time, the VPN client function unit 1111 receives notification indicating that the authentication processing has succeeded from the VPN server 200.

As described above, after the communication based on the device authentication is established, the VPN client function unit 1111 transmits the user authentication information, which is authentication information regarding the user, to the VPN server 200 in response to the logon of the user to the OS 130.

The routing function unit 1112 controls traffic after the communication with the VPN server 200 is established. For example, after the OS 130 is activated by the hypervisor 110, a network request is made by a user operation, an operation of the application on the OS 130, or the like. The network request in that case includes, for example, access to a specific resource in the internal system. At this time, the routing function unit 1112 receives the network request. Then, in response to the network request, the routing function unit 1112 communicates with a desired access destination via the VPN tunnel. For example, a network packet in response to the network request is transmitted to the VPN server 200 through the VPN tunnel. The VPN server 200 determines to transfer the received packet to an appropriate destination according to the ACL based on the authentication. The routing function unit 1112 further receives the network packet from the VPN server 200. Then, the routing function unit 1112 transfers the network packet to an appropriate destination such as the OS 130, an application, or the like.

The VPN server 200 includes an authentication unit 210, an access control unit 220, and a session management unit 230. The VPN server 200 further includes a storage unit 290. There may be a plurality of the storage units 290. The storage unit 290 may be constructed in a device outside the VPN server 200 communicably connected to the VPN server 200.

The authentication unit 210 performs authentication processing in response to a request from the communication control device. The authentication unit 210 is an example of an authentication means.

Specifically, the authentication unit 210 obtains authentication information transmitted from the communication control device 100. For example, the authentication unit 210 obtains the device authentication information or the user authentication information by receiving the authentication response packet. Then, the authentication unit 210 verifies the obtained authentication information to confirm authenticity of the device or user. For example, the authentication unit 210 checks whether the device associated with the device authentication information is registered. If the device authentication information is a certificate, the authentication unit 210 may check an issuer, a validity period, an expiration status, and the like of the certificate. For example, the authentication unit 210 further checks whether the user associated with the user authentication information is registered. If the user authentication information is a password, biometric information, and the like, it may be determined whether the user authentication information matches information registered in advance. Then, the authentication unit 210 outputs an authentication result.

The access control unit 220 controls a range accessible from the communication control device 100 depending on the authentication result. The access control unit 220 is an example of an access control means.

Specifically, if the authentication has succeeded, the access control unit 220 selects an ACL to be applied to the communication control device 100. In the ACL, an accessible range is set depending on a type of the device or user to be authenticated. For example, in the ACL, authority to access the system, resources, and the like for internal use is set depending on the type of the device or user. The ACL is stored in the storage unit 290.

Here, the type of the device or user may be authentication information, or may be profile information different from the authentication information. If the device authentication has succeeded, for example, the access control unit 220 selects the ACL according to the device ID, certificate, and the like of the device that has been successfully authenticated. Then, the access control unit 220 registers the selected ACL in association with session information related to the communication control device 100. The session information is generated by the session management unit 230. Details of the session information will be described later. Likewise, if the user authentication has succeeded, for example, the access control unit 220 selects the ACL according to the user ID and the like of the user who has been successfully authenticated. Then, the access control unit 220 registers the selected ACL in association with session information related to the communication control device 100.

The ACL selected upon successful device authentication may be different from the ACL selected upon successful user authentication. That is, the access control unit 220 may change the accessible range set at the time of successful device authentication and the accessible range set at the time of successful user authentication with respect to the communication control device 100. In other words, the access control unit 220 sets the range accessible from the communication control device 100 if the authentication using the authentication information regarding the device has succeeded. Then, the access control unit 220 updates the range accessible from the communication control device 100 if the authentication using the authentication information regarding the user has further succeeded. As a result, for example, the access control unit 220 may perform processing in such a way that authority to access a predetermined range is acknowledged at the time of successful device authentication and authority to access a range equal to or more than the predetermined range is acknowledged at the time of successful user authentication.

The session management unit 230 manages a session between the communication control device 100 and the VPN server 200. Specifically, upon reception of the VPN connection request, the session management unit 230 performs an initial handshake with the communication control device 100. The session management unit 230 further makes notification to the communication control device 100 depending on the authentication result. For example, if the authentication has succeeded, the session management unit 230 generates session information and establishes a VPN tunnel. The session information includes a session ID, a session validity period, a device ID, a user ID, a client IP address, and the like. At this time, the session management unit 230 may notify the communication control device 100 of the successful authentication at the time of establishing the VPN tunnel.

As described above, if the authentication has succeeded, the session management unit 230 establishes communication with the communication control device 100. The session management unit 230 is an example of a session management means.

### Exemplary Operation of Communication Control System 1000

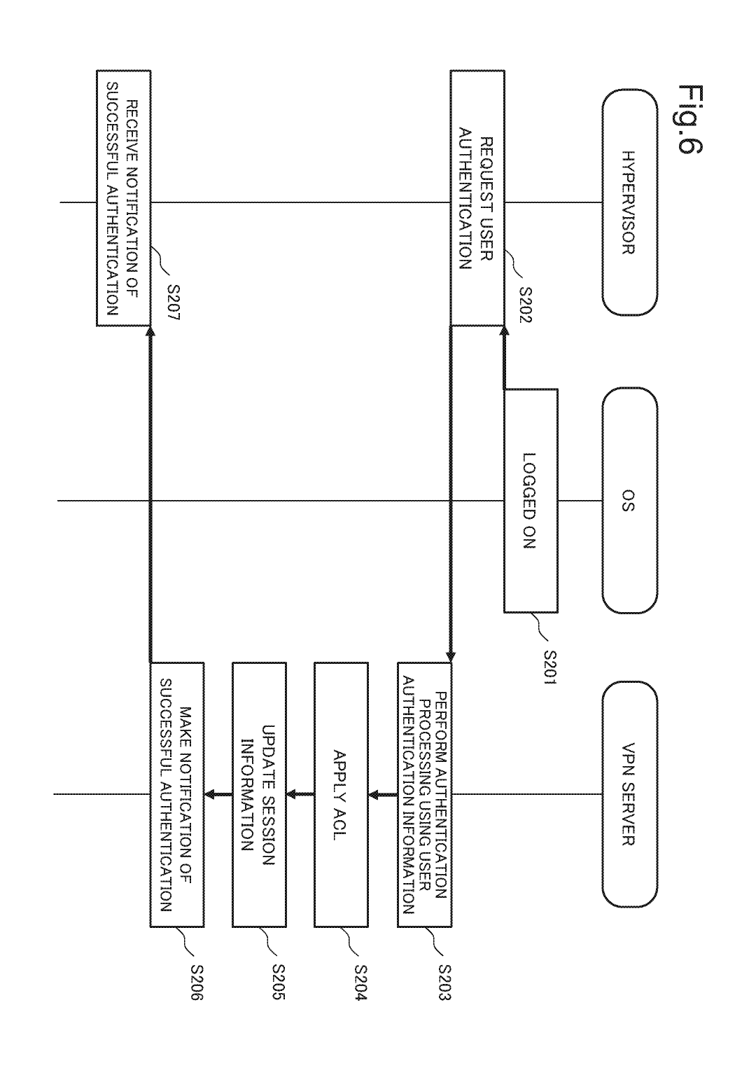

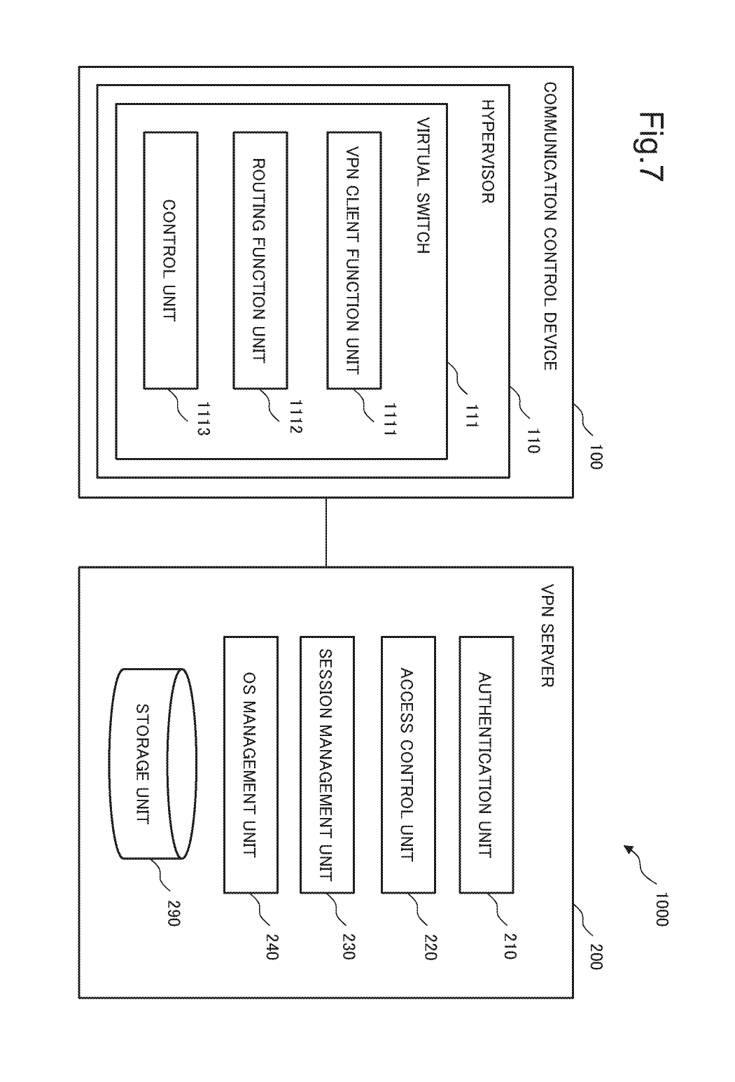

Next, an exemplary operation of the communication control system 1000 will be described with reference to FIGS. 5 and 6. In the present disclosure, steps in a flowchart will be represented using numbers assigned to the steps, such as “S101”. FIG. 5 is a first sequence diagram for explaining an exemplary operation of the communication control system 1000. In the present operation example, descriptions will start from a situation where the communication control device 100 is activated. In the present operation example, an exemplary case where the authentication has succeeded will be described.

First, upon startup of the hardware 120 of the communication control device 100, the hardware 120 supplies power to the UEFI (S101). The UEFI starts the hypervisor 110 (S102). The VPN client function unit 1111 of the hypervisor 110 requests VPN connection (S103). At this time, the VPN client function unit 1111 reads the connection information of the VPN server 200 set in advance. Then, the VPN client function unit 1111 may transmit a connection request packet to the VPN server 200 based on the connection information, thereby requesting VPN connection. A transmission path of the connection request packet is determined by the routing function unit 1112.

Upon reception of the VPN connection request, the session management unit 230 of the VPN server 200 executes an initial handshake (S104). At this time, the session management unit 230 may determine that the VPN connection request has been accepted by reception of the connection request packet.

The VPN client function unit 1111 of the hypervisor 110 requests device authentication (S105). Specifically, the VPN client function unit 1111 transmits an authentication response packet including the device authentication information to the VPN server 200. At this time, a transmission path of the authentication response packet is determined by the routing function unit 1112. The transmission path of the authentication response packet may be determined based on the connection established by the initial handshake.

The authentication unit 210 of the VPN server 200 performs authentication processing using the transmitted device authentication information (S106). For example, the authentication unit 210 verifies the device authentication information. If authenticity of the device is confirmed, the authentication unit 210 determines that the authentication has succeeded. The session management unit 230 generates session information (S107). The access control unit 220 applies the ACL to the communication control device 100 (S108). For example, the access control unit 220 selects the ACL according to the device ID, certificate, and the like of the device that has been successfully authenticated. Then, the access control unit 220 registers the selected ACL in association with session information related to the communication control device 100. The session management unit 230 establishes a VPN tunnel (S109). At this time, the session management unit 230 notifies the communication control device 100 of the successful authentication.

The VPN client function unit 1111 of the hypervisor 110 receives the notification regarding the successful authentication (S110).

Thereafter, the hypervisor 110 starts the OS 130 (S111). After the startup of the OS, a network request is made from the OS 130, an application on the OS 130, or the like (S112). In response to the network request, the routing function unit 1112 communicates with a desired access destination via the VPN tunnel (S113).

As described above, the communication control system 1000 may establish encrypted communication and perform communication after the establishment of the encrypted communication using the virtual switch 111 of the hypervisor 110 without intervention of the OS. Furthermore, in this example, the communication control system 1000 establishes the encrypted communication after the startup of the hypervisor 110 and before the startup of the OS 130. By performing the processing as in this example, the communication control system 1000 is enabled to achieve communication based on the device authentication related to the communication control device 100.

FIG. 6 is a second sequence diagram for explaining an exemplary operation of the communication control system 1000. More specifically, FIG. 6 is an exemplary operation of the communication control system 1000 after the process of FIG. 5 is executed. That is, FIG. 6 is an exemplary operation after the encrypted communication is implemented based on the device authentication.

It is assumed that the user has logged on in the OS 130 (S201). At this time, the VPN client function unit 1111 requests user authentication (S202). For example, the VPN client function unit 1111 transmits an authentication response packet including the user authentication information to the VPN server 200.

The authentication unit 210 of the VPN server 200 performs authentication processing using the transmitted user authentication information (S203). For example, the authentication unit 210 verifies the user authentication information. If authenticity of the user is confirmed, the authentication unit 210 determines that the authentication has succeeded. The access control unit 220 applies the ACL to the communication control device 100 (S204). For example, the access control unit 220 selects the ACL according to the user authentication information of the user who has been successfully authenticated. Then, the access control unit 220 updates the session information based on the selected ACL (S205). Specifically, the access control unit 220 registers the selected ACL in association with the session information. The session management unit 230 notifies the communication control device 100 of the successful authentication (S206).

The VPN client function unit 1111 of the hypervisor 110 receives the notification regarding the successful authentication (S207).

As described above, the communication control system 1000 may implement the communication based on the user authentication after the startup of the OS. Even in this case, the communication control system 1000 may implement the encrypted communication via the virtual switch 111 of the hypervisor 110. After the processing of S207, the network request from the OS 130 is made based on the re-applied ACL. That is, it can be said that the communication control system 1000 may set the accessible range based on the device authentication and the user authentication.

The exemplary operation described above is merely an example. That is, the operation of the communication control system 1000 according to the present disclosure is not limited to the example described above. For example, the order of performing each processing may be changed within a range that raises no contradiction of processing.

As described above, the communication control device 100 according to the second example embodiment includes the hypervisor 110 implemented in the hardware 120 without intervention of the host OS. At this time, the hypervisor 110 includes the virtual switch 111 that controls communication with the connection destination. The hypervisor 110 routes communication originating from the OS to the connection destination and communication originating from the connection destination to the device through the virtual switch 111.

As a result, communication control in a layer below the OS 130 is achieved, whereby the communication control device 100 is enabled to perform communication control regardless of a type of the OS 130. Routing the communication through the virtual switch included in the hypervisor 110 is equivalent to communication being performed under the management of the hypervisor 110. That is, OS-independent communication control is performed. Thus, for example, it becomes difficult for an attacker to exploit vulnerability of the OS or vulnerability of an application on the OS to bypass the OS to access the network. That is, the communication control device 100 may suppress occurrence of a problem caused by the OS.

The virtual switch 111 of the communication control device 100 includes the VPN client function unit 1111 that establishes communication with the VPN server 200, and the routing function unit 1112 that performs routing control based on the destination for communication originating from its own device and communication originating from the connection destination.

At this time, the VPN client function unit 1111 may transmit the device authentication information, which is the authentication information regarding the device, to the VPN server 200 to establish communication with the VPN server 200 after the startup of the hypervisor 110 and before the startup of the OS 130. As a result, the communication control device 100 is enabled to establish encrypted communication with the VPN server 200 without using the OS 130. That is, the communication control device 100 may perform OS-independent communication control.

After the communication is established, the VPN client function unit 1111 may transmit the user authentication information, which is authentication information regarding the user, to the VPN server in response to the logon of the user to the OS 130. As a result, the communication control device 100 is enabled to request the VPN server 200 to authenticate the user. Thus, for example, the communication control device 100 may request an access in a range wider than the accessible range applied based on the device authentication.

As described above, the communication control system 1000 includes the communication control device 100 and the VPN server 200. At this time, the communication control device 100 includes the hypervisor 110 implemented in the hardware 120 without intervention of the host OS, the hypervisor 110 includes the virtual switch 111 that controls communication with the connection destination, and the hypervisor 110 routes communication originating from its own device to the connection destination and communication originating from the connection destination to the device through the virtual switch 111. The virtual switch 111 includes the VPN client function unit 1111 that establishes communication with the VPN server, and the routing function unit 1112 that performs routing control based on the destination for communication originating from the device and communication originating from the connection destination. The VPN server 200 includes the authentication unit 210 that performs authentication processing in response to a request from the communication control device 100, the access control unit 220 that controls the range accessible from the communication control device 100 based on the authentication result, and the session management unit 230 that establishes communication with the communication control device 100 if the authentication has succeeded.

As a result, OS-independent communication control is performed. That is, occurrence of a problem caused by the OS may be suppressed also in the communication control system 1000. In the VPN server 200 of the communication control system 1000, encrypted communication may be established by the authentication processing, and the range accessible from the communication control device 100 may be set. That is, the communication control system 1000 may manage the client access control in the VPN server 200 in a centralized manner.

Furthermore, the communication control system 1000 transmits the authentication information to the VPN server 200 using the VPN client function unit 1111. At this time, the authentication unit 210 performs authentication processing using the authentication information. Then, the access control unit 220 sets the range accessible from the communication control device 100 if the authentication using the authentication information regarding the device has succeeded, and further updates the range accessible from the communication control device 100 if the authentication using the authentication information regarding the user has succeeded.

As a result, the communication control system 1000 may perform access control on the client in a centralized manner on the side of the VPN server 200, and may achieve a dynamic access range setting based on the device authentication and the user authentication.

### First Modified Example

A communication control system 1000 may set an accessible range more dynamically. At this time, a session management unit 230 monitors a communication control device 100 in a session.

Specifically, the session management unit 230 detects a change in a state of the communication control device 100 in the session. Examples of the state change include a case where geographical positional information of the communication control device 100 has changed. In that case, a VPN client function unit 1111 periodically transmits the positional information of the communication control device 100 to a VPN server 200. For example, the session management unit 230 detects that the communication control device 100 has moved from company premises to the outside of the premises based on the positional information. Examples of the state change further include a change in a network environment. For example, the session management unit 230 detects that a network connected with the communication control device 100 has changed from secure Wi-Fi to public Wi-Fi. Examples of the state change further include a change in a time period during which an access has been made. For example, the session management unit 230 detects that the communication control device 100 has made an access at a time other than preset business hours.

The state change is not limited to this example. For example, the session management unit 230 may detect simultaneous connection of the same user, a change in an access attempt pattern of the user, or the like.

If a state change is detected by the session management unit 230, an access control unit 220 selects an ACL depending on the state change. Specifically, the access control unit 220 registers the selected ACL in association with the session information.

For example, it is assumed that the network connected with the communication control device 100 has changed from secure Wi-Fi to public Wi-Fi. In that case, the access control unit 220 selects an ACL whose access range is narrower than that in the case of being connected to the secure Wi-Fi.

As described above, the communication control system 1000 may dynamically set the access range depending on the situation. In particular, with the processing described above being performed, the access range may be managed in a centralized manner on the side of the VPN server 200.

### Second Modified Example

If authentication has failed, an authentication unit 210 may generate an error message. Then, the authentication unit 210 transmits an error message to a communication control device 100.

A session management unit 230 may record the number of authentication failures. Then, if the number of authentication failures is equal to or more than a predetermined threshold, the session management unit 230 may reject connection from the same communication control device 100 for a certain period of time. If the number of authentication failures is equal to or more than the predetermined threshold, the session management unit 230 may transmit an alert to a security monitoring system (not illustrated).

### Third Modified Example

A hypervisor 110 may obtain an OS before a startup of the OS. The acquisition of the OS includes an update of the OS.

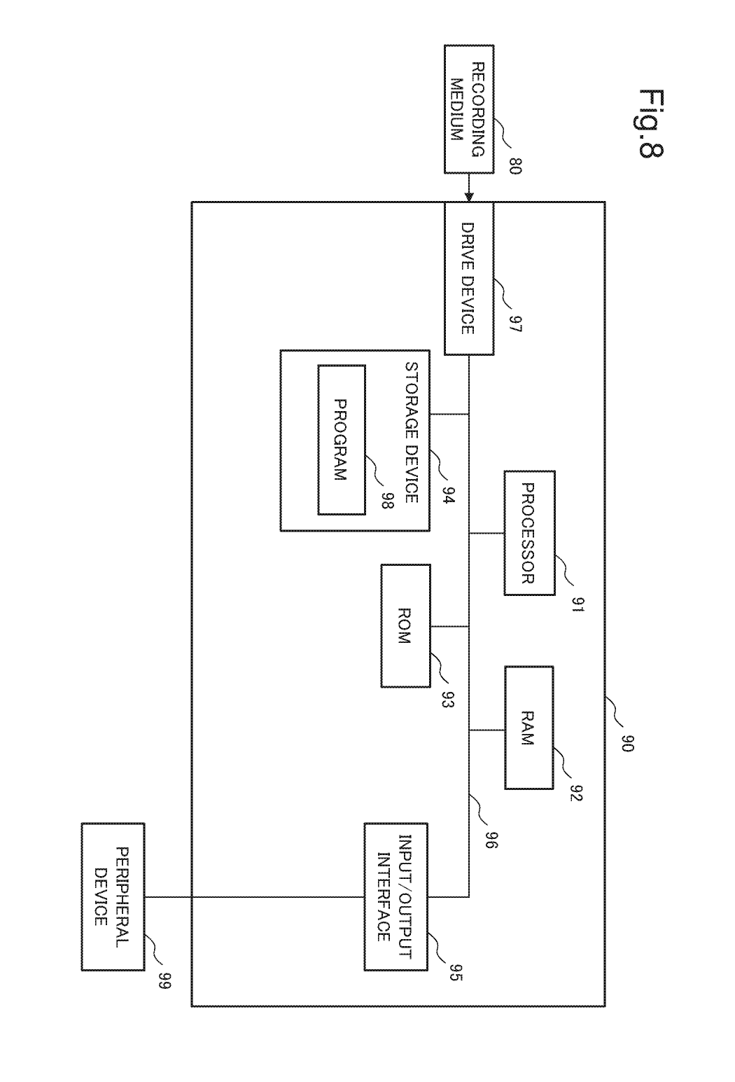

FIG. 7 is a second block diagram illustrating an exemplary functional configuration of a communication control system 1000. As illustrated in FIG. 7, the communication control system 1000 includes a communication control device 100 and a VPN server 200. At this time, a hypervisor 110 of the communication control device 100 may include a control unit 1113. While the control unit 1113 is provided in a virtual switch 111 in this example, the control unit 1113 may be implemented as a functional unit of the hypervisor 110 different from the virtual switch 111. The control unit 1113 is an example of a control means.

Specifically, it is assumed that the processing up to S110 has been performed in the exemplary operation of FIG. 5. At this time, the control unit 1113 of the hypervisor 110 obtains information regarding a type of a user of the device. The information regarding the type of the user in this case may be information for identifying the user, such as a user ID of the user who uses the communication control device 100, or may be information indicating an attribute of the user, such as affiliation, a post, and the like of the user. The information regarding the type of the user is stored in a storage device (not illustrated) included in the communication control device 100. Then, the control unit 1113 transmits the information regarding the type of the user to the VPN server 200.

The VPN server 200 may include an OS management unit 240. The OS management unit 240 identifies the OS based on the information regarding the type of the user transmitted from the communication control device 100. For example, an OS management table in which the information regarding the type of the user is associated with the OS is stored in a storage unit 290. At this time, the OS management table indicates a storage location of a file required to install the OS related to each OS. Examples of the file required to install the OS include an International Organization for Standardization (ISO) file.

The OS management unit 240 identifies the OS associated with the transmitted information regarding the type of the user. Then, the OS management unit 240 causes the communication control device 100 to install the file required to install the identified OS. At this time, the OS management unit 240 may obtain the file required to install the OS, and may transmit the file to the communication control device 100. In that case, the control unit 1113 installs the transmitted file into the communication control device 100. Alternatively, the OS management unit 240 may transmit information indicating the storage location of the file to the communication control device. In that case, the control unit 1113 downloads and installs the file from the storage location of the file.

As described above, the control unit 1113 obtains the information regarding the type of the user of the device, and obtains the OS according to the type of the user. That is, the communication control system 1000 may obtain the OS according to the type of the user after the startup of the hypervisor and before the startup of the OS. Thus, the communication control system 1000 may use the OS desired to be used depending on the user.

### Fourth Modified Example

In a communication control system 1000 according to the present disclosure, a function of remote attestation may be implemented. The remote attestation is a mechanism for verifying device integrity, authenticity, and the like. In that case, a VPN server may serve as a remote attestation procedures (RATs) server.

Specifically, a VPN client function unit 1111 of a hypervisor 110 reads device authentication information recorded in hardware 120. At this time, a security module such as a trusted platform module (TPM) is incorporated in the hardware 120. The security module stores a platform certificate including information regarding the hardware 120, information regarding software incorporated in a communication control device 100, and the like. The VPN client function unit 1111 transmits, for example, such a platform certificate to a VPN server 200 as device authentication information.

An authentication unit 210 of the VPN server 200 performs authentication processing using the transmitted device authentication information. At this time, information similar to the platform certificate is stored in a storage unit 290. The authentication unit 210 verifies the device authentication information using the transmitted device authentication information and the information stored in the storage unit 290.

An access control unit 220 selects an ACL to be applied depending on a result of the verification. At this time, if the integrity and the like of the communication control device 100 is confirmed by the verification, the access control unit 220 may apply a normal ACL, and a limited ACL may be applied if a suspicious point is detected by the verification.

### Exemplary Hardware Configuration of Communication Control Device

Hardware for constructing the above-described communication control device according to the first and second example embodiments will be described. FIG. 8 is a block diagram illustrating an exemplary hardware configuration of a computer device constituting the communication control device according to the example embodiments. In a computer device 90, the communication control device and the communication control method described in the example embodiments and modified examples are implemented. For example, the communication control device and the like described in the example embodiments and modified examples may have the hardware configuration illustrated in FIG. 8.

As illustrated in FIG. 8, the computer device 90 includes a processor 91, a random access memory (RAM) 92, a read only memory (ROM) 93, a storage device 94, an input/output interface 95, a bus 96, and a drive device 97. The communication control device and the like may be implemented by a plurality of electric circuits.

The storage device 94 stores a program (computer program) 98. The processor 91 executes the program 98 of the present communication control device using the RAM 92. Specifically, for example, the program 98 includes a program for causing a computer to execute the processes illustrated in, for example, FIGS. 5 and 6. In response to the execution of the program 98 by the processor 91, the functions of the components of the present communication control device are implemented. The program 98 may be stored in the ROM 93. The program 98 may be recorded in a recording medium 80 and read using the drive device 97, or may be transmitted from an external device (not illustrated) to the computer device 90 via a network (not illustrated). For example, the program 98 may be installed, and a hypervisor may be implemented in the BIOS or UEFI.

The input/output interface 95 exchanges data with a peripheral device (e.g., keyboard, mouse, display device, etc.) 99. The input/output interface 95 functions as a means for obtaining or outputting data. The bus 96 connects the components with each other.

There are various modified examples of the method for implementing the communication control device. For example, each component included in the communication control device may be implemented as a dedicated device. The communication control device may be implemented based on a combination of a plurality of devices.

A processing method for causing a recording medium to record a program for implementing each component in the function of each example embodiment, reading the program recorded in the recording medium as a code, and causing a computer to execute the program is also included in the scope of each example embodiment. That is, a computer-readable recording medium is also included in the scope of each example embodiment. The recording medium recording the program described above and the program itself are also included in each example embodiment.

The recording medium is, for example, a floppy (registered trademark) disk, a hard disk, an optical disk, a magneto-optical disk, a compact disc (CD)-ROM, a magnetic tape, a nonvolatile memory card, or a ROM, but is not limited to this example. The program recorded in the recording medium is not limited to a program for executing processing by itself, and programs that run on an operating system (OS) to execute processing in cooperation with other software and functions of an extension board are also included in the scope of each example embodiment.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims.

The example embodiments and modified examples described above may be appropriately combined with each other.

### SUPPLEMENTARY NOTE

Some or all of the above example embodiments may be described as, but are not limited to, the following Supplementary Notes.

### Supplementary Note 1

A communication control device including:
a hypervisor implemented in hardware without intervention of a host OS, in which
the hypervisor includes a virtual switch that controls communication with a connection destination, and
the hypervisor routes the communication originating from the communication control device to the connection destination and the communication originating from the connection destination to the communication control device through the virtual switch.

### Supplementary Note 2

The communication control device according to Supplementary Note 1, in which the virtual switch includes:
a VPN client means for establishing communication with a VPN server; and
a routing means for performing routing control based on a destination for the communication originating from the communication control device and the communication originating from the connection destination.

### Supplementary Note 3

The communication control device according to Supplementary Note 2, in which the VPN client means is configured to:
transmit device authentication information, which is authentication information regarding the communication control device, to the VPN server after a startup of the hypervisor and before a startup of an OS, and establish the communication with the VPN server.

### Supplementary Note 4

The communication control device according to Supplementary Note 3, in which the VPN client means is configured to:
transmit user authentication information, which is authentication information regarding a user, to the VPN server in response to a logon of the user to the OS after the communication is established.

### Supplementary Note 5

The communication control device according to Supplementary Note 1,

in which the hypervisor further includes a control means for obtaining information regarding a type of a user of the communication control device and obtaining an OS according to the type of the user.

### Supplementary Note 6

The communication control device according to any one of Supplementary Notes 1 to 5,

in which the hypervisor is implemented in a BIOS layer or in a UEFI layer.

### Supplementary Note 7

A communication control system including:
a communication control device; and a VPN server, in which
the communication control device includes a hypervisor implemented in hardware without intervention of a host OS,
the hypervisor includes a virtual switch that controls communication with a connection destination,
the hypervisor routes the communication originating from the communication control device to the connection destination and the communication originating from the connection destination to the communication control device through the virtual switch,
the virtual switch includes:
a VPN client means for establishing communication with the VPN server; and
a routing means for performing routing control based on a destination for the communication originating from the communication control device and the communication originating from the connection destination, and
the VPN server includes:
an authentication means for executing authentication processing in response to a request from the communication control device;
an access control means for controlling a range accessible from the communication control device depending on a result of the authentication; and
a session management means for establishing the communication with the communication control device in response to successful authentication.

### Supplementary Note 8

The communication control system according to Supplementary Note 7, in which

the VPN client means transmits authentication information to the VPN server,

the authentication means executes the authentication processing using the authentication information, and

the access control means is configured to:

set the range accessible from the communication control device in response to successful authentication using the authentication information regarding a device; and

update the range accessible from the communication control device in response to further successful authentication using the authentication information regarding a user.

### Supplementary Note 9

A communication control method including:
causing a hypervisor implemented in hardware without intervention of a host OS to:
route communication originating from an OS to a connection destination and communication originating from the connection destination to a communication control device through a virtual switch that controls the communication with the connection destination, the virtual switch being included in the hypervisor.

### Supplementary Note 10

A program for causing a hypervisor implemented in hardware without intervention of a host OS to perform a process including:
routing communication originating from an OS to a connection destination and communication originating from the connection destination to a communication control device through a virtual switch that controls the communication with the connection destination, the virtual switch being included in the hypervisor.

Some or all of the configurations described in Supplementary Notes 2 to 8 dependent on Supplementary Note 1 described above may also be dependent on Supplementary Notes 9 and 10 with dependency relationships similar to those in Supplementary Notes 2 to 8. Some or all of the configurations described as a Supplementary Note may be similarly dependent on various types of hardware, software, various recording means for recording software, or systems without departing from the example embodiments described above.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. A communication control device comprising:
one or more memories storing instructions; and
one or more processors configured to execute the instructions, wherein
a hypervisor implemented by the one or more processors executing the instructions
operates on hardware without intervention of a host OS,
comprises a virtual switch including a routing table, the virtual switch having a function of managing routing to a connection destination, and
routes the communication originating from the communication control device to the connection destination and the communication originating from the connection destination to the communication control device through the virtual switch.

2. The communication control device according to claim 1, wherein
the virtual switch is configured to:
establish communication with a VPN server; and
perform routing control based on a destination for the communication originating from the communication control device and the communication originating from the connection destination.

3. The communication control device according to claim 2, wherein
the virtual switch is configured to:
transmit device authentication information, which is authentication information regarding the communication control device, to the VPN server after a startup of the hypervisor and before a startup of an OS, and establish the communication with the VPN server.

4. The communication control device according to claim 3, wherein
the virtual switch is configured to:
transmit user authentication information, which is authentication information regarding a user, to the VPN server in response to a logon of the user to the OS after the communication is established.

5. The communication control device according to claim 1, wherein
the hypervisor is configured to:
obtain information regarding a type of a user of the communication control device; and
obtain an OS according to the type of the user.

6. The communication control device according to claim 1,
wherein the hypervisor is implemented in a basic input/output system (BIOS) layer or in a unified extensible firmware interface (UEFI) layer.

7. A communication control system comprising:
a communication control device; and
a VPN server, wherein
the communication control device includes:
one or more memories that store instructions; and
one or more processors configured to execute the instructions,
a hypervisor implemented by the one or more processors executing the instructions
operates on hardware without intervention of a host OS,
comprises a virtual switch including a routing table, the virtual switch having a function of managing routing to a connection destination, and
routes the communication originating from the communication control device to the connection destination and the communication originating from the connection destination to the communication control device through the virtual switch,
the virtual switch is configured to:
establish communication with the VPN server; and
perform routing control based on a destination for the communication originating from the communication control device and the communication originating from the connection destination,
the VPN server includes:
at least one memory that stores instructions; and
at least one processor configured to execute the instructions, and
the at least one processor of the VPN server is configured to:
execute authentication processing in response to a request from the communication control device;
control a range accessible from the communication control device depending on a result of the authentication; and
establish the communication with the communication control device in response to successful authentication.

8. The communication control system according to claim 7, wherein
the virtual switch transmits authentication information to the VPN server,
the at least one processor of the VPN server executes the authentication processing using the authentication information, and
the at least one processor of the VPN server is configured to:
set the range accessible from the communication control device in response to successful authentication using the authentication information regarding a device; and
update the range accessible from the communication control device in response to further successful authentication using the authentication information regarding a user.

9. The communication control system according to claim 7, wherein
the hypervisor is configured to:
obtain information regarding a type of a user of the communication control device; and
obtain an OS according to the type of the user.

10. The communication control system according to claim 7,
wherein the hypervisor is implemented in a basic input/output system (BIOS) layer or in a unified extensible firmware interface (UEFI) layer.

11. A communication control method comprising:
causing a hypervisor that operates on hardware without intervention of a host OS to:
route communication originating from a communication control device to a connection destination and communication originating from the connection destination to the communication control device through a virtual switch included in the hypervisor, the virtual switch including a routing table and having a function of managing routing to the connection destination.

12. The communication control method according to claim 11, further comprising:
causing the virtual switch to:
establish communication with a VPN server; and
perform routing control based on a destination for the communication originating from the communication control device and the communication originating from the connection destination.

13. The communication control method according to claim 12, further comprising:
causing the virtual switch to:
transmit device authentication information, which is authentication information regarding the communication control device, to the VPN server after a startup of the hypervisor and before a startup of the OS, and to establish the communication with the VPN server.

14. The communication control method according to claim 13, further comprising:
causing the virtual switch to:
transmit user authentication information, which is authentication information regarding a user, to the VPN server in response to a logon of the user to the OS after the communication is established.

15. The communication control method according to claim 11, further comprising:
causing the hypervisor to:
obtain information regarding a type of a user of the communication control device; and
obtain an OS according to the type of the user.

16. The communication control method according to claim 11,
wherein the hypervisor is implemented in a basic input/output system (BIOS) layer or in a unified extensible firmware interface (UEFI) layer.
